(19) United States
(12) Patent Application Publication
(10) Pub. No.: US 2011/0278397 A1
(43) Pub. Date: Nov. 17, 2011

(54) ALUMINUM-COPPER-LITHIUM ALLOY FOR A LOWER WING SKIN ELEMENT

(75) Inventors: Bernard BES, Seyssins (FR); Frank EBERL, Issoire (FR); Gaelle POUGET, Grenoble (FR)

(73) Assignee: ALCAN RHENALU, Courbevoie (FR)

(21) Appl. No.: 13/106,395

(22) Filed: May 12, 2011

Related U.S. Application Data
(60) Provisional application No. 61/334,446, filed on May 13, 2010.

(30) Foreign Application Priority Data
May 12, 2010 (FR) 1002033

(51) Int. Cl. B64C 3/26; C22C 21/16; C22C 21/14; C22F 1/057

(52) U.S. Cl. 244/123.1; 148/550; 148/552; 420/533; 420/535

(57) ABSTRACT

The present disclosure relates to an alloy containing aluminum including, as a % by weight, 2.1 to 2.4% of Cu, 1.3 to 1.6% of Li, 0.1 to 0.5% of Ag, 0.2 to 0.6% of Mg, 0.05 to 0.15% of Zr, 0.1 to 0.5% of Mn, 0.01 to 0.12% of Ti, optionally at least one element chosen from among Cr, Sc, and Hf, the quantity of the element, if it is chosen, being from 0.05 to 0.3% for Cr and Sc, 0.05 to 0.5% for Hf, a quantity of Fe and Si each less than or equal to 0.1 and inevitable impurities at a rate of less than or equal to 0.05 each and 0.15 in total. The alloy can be used to produce extruded, rolled and/or forged products particularly suitable for the manufacture of elements for the lower wing skin of aircrafts.

### CROSS REFERENCE TO RELATED APPLICATIONS

This application claims priority to U.S. Provisional Application Serial No. U.S. App. 61/334,446 filed May 13, 2010 and FR 1002033 filed May 12, 2010, the contents of which are incorporated herein by reference in their entireties.

### FIELD OF THE INVENTION

The present invention in general relates to aluminum alloy products and, more particularly, such products, their use and manufacturing processes, in particular in the aerospace industry.

### BACKGROUND OF RELATED ART

A continuous research effort is being made in order to develop materials which can simultaneously reduce the weight and increase the effectiveness of the structures of high-performance aircraft. Aluminum-lithium alloys (AlLi) are of great interest in this respect, because lithium can reduce the density of aluminum by 3% and increase the modulus of elasticity by 6% for each percent of added lithium weight.

U.S. Pat. No. 5,032,359 describes a vast family of aluminum-copper-lithium alloys in which the addition of magnesium and silver, in particular between 0.3 and 0.5 percent by weight, makes it possible to increase the mechanical resistance.

U.S. Pat. No. 5,198,045 describes a family of alloys including (as a % by weight) (2.4-3.5) Cu, (1.35-1.8) Li, (0.25-0.65) Mg, (0.25-0.65) Ag, (0.08-0.25) Zr. Work-hardened products manufactured with these alloys combine a density of less than 2.64 g/cm3 and a useful compromise between mechanical resistance and fracture toughness.

U.S. Pat. No. 7,229,509 describes a family of alloys including (as a % by weight) (2.5-5.5) Cu, (0.1-2.5) Li, (0.2-1.0) Mg, (0.2-0.8) Ag, (0.2-0.8) Mn, (up to 0.4) Zr or other refining agents such as Cr, Ti, Hf, Sc and V. The examples given have an improved compromise between mechanical resistance and fracture toughness but their density is greater than 2.7 g/cm3.

Patent EP 1.966.402 describes an alloy that does not contain zirconium designed for fuselage sheets with a primarily recrystallized structure including (as a % by weight) (2.1-2.8) Cu, (1.1-1.7) Li, (0.2-0.6) Mg, (0.1-0.8) Ag, (0.2-0.6) Mn.

Patent EP 1.891.247 describes an alloy designed for fuselage sheets including (as a % by weight) (3.0-3.4) Cu, (0.8-1.2) Li, (0.2-0.6) Mg, (0.2-0.5) Ag and at least one element out of Zr, Mn, Cr, Sc, Hf and Ti, in which the Cu and Li contents meet the condition Cu+5/3 Li<5.2.

U.S. Pat. No. 5,455,003 describes a process for the production of aluminum-copper-lithium alloys with improved properties of mechanical resistance and fracture toughness at cryogenic temperatures. This process applies in particular to an alloy including (as a % by weight) (2.0-6.5) Cu, (0.2-2.7) Li, (0-4.0) Mg, (0-4.0) Ag, (0-3.0) Zn.

International patent application WO 2010/055225 describes a process for manufacturing an extruded, rolled and/or forged product based on an aluminium alloy in which: a bath of liquid metal is produced that comprises 2.0 to 3.5 wt % Cu, 1.4 to 1.8 wt % Li, 0.1 to 0.5 wt % Ag, 0.1 to 1.0 wt % Mg, 0.05 to 0.18 wt % Zr, 0.2 to 0.6 wt % Mn and at least one element chosen from Cr, Sc, Hf and Ti, the amount of said element, if it is chosen, being 0.05 to 0.3 wt % in the case of Cr and Sc, 0.05 to 0.5 wt % in the case of Hf and 0.01 to 0.15 wt % in the case of Ti, the balance being aluminium and inevitable impurities; an unwrought product is cast from the liquid metal bath and said unwrought product is homogenized at a temperature from 515° C. to 525° C. so that the time equivalent to 520° C. for the homogenization is from 5 to 20 hours.

Alloy AA2196 including is also known, including (as a % by weight) (2.5-3.3) Cu, (1.4-2.1) Li, (0.25-0.8) Mg, (0.25-0.6) Ag, (0.04-0.18) Zr and at the most 0.35 Mn.

Certain parts intended for aeronautical engineering require a particular compromise of properties that these known alloys do not make it possible to attain.

In particular, parts used in the manufacture of lower wing skins for aircraft require very high fracture toughness, yet with sufficient mechanical resistance. These properties have to be thermally stable, i.e. they must not change significantly during ageing treatment at a temperature such as 85° C. Obtaining all these properties simultaneously with the lowest possible density is a desirable compromise of properties.

There is a need for a thermally stable Al—Cu—Li alloy, of low density and with very high fracture toughness yet with sufficient mechanical resistance, for aeronautical applications and in particular for lower wing skin applications.

### SUMMARY OF THE INVENTION

A first subject of the invention is an aluminum based alloy comprising
2.1 to 2.4% by weight of Cu,
1.3 to 1.6% by weight of Li,
0.1 to 0.5% by weight of Ag,
0.2 to 0.6% by weight of Mg,
0.05 to 0.15% by weight of Zr,
0.1 to 0.5% by weight of Mn,
0.01 to 0.12% by weight of Ti
   optionally at least one element chosen among Cr, Sc, and Hf, the amount of the element, if it is chosen, being from 0.05 to 0.3% by weight for Cr and Sc, 0.05 to 0.5% by weight for Hf,
   a quantity of Fe and Si each less than or equal to 0.1% by weight, and inevitable impurities each with a content less than or equal to 0.05% by weight one and 0.15% by weight in total.

A second subject of the invention is an extruded flat-rolled and/or forged product including an alloy according to the invention.

Still another subject of the invention is a manufacturing process for a product according to the invention in which:

(a) a rough form is cast in an alloy according to the invention,
(b) said rough form is homogenized at 480 to 540° C. for 5 to 60 hours,
(c) said rough form is hot worked by extrusion, rolling and/or forging at an initial hot working temperature of 400 to 500° C. into an extruded, tolled an/or forged product,
(d) said product undergoes a solution heat-treatment at 490 to 530° C. for 15 minutes to 8 hours,
(e) it is quenched,
(f) said product undergoes controlled stretching with a permanent set of 1 to 5%,
(g) said product is aged by heating to a temperature of 120 to 170° C. for 5 to 100 hours.

Still another subject of the invention is the use of a product according to the invention as an element of the lower wing skin of an aircraft.

### BRIEF DESCRIPTION OF THE DRAWINGS

FIG. 1. Shape of the profile in example 1. The dimensions are indicated in mm. The thickness of the bottom is 26.3 mm.

### DETAILED DESCRIPTION OF A PREFERRED EMBODIMENT

Unless otherwise stated, all the indications concerning the chemical composition of the alloys are expressed as a percentage by weight based on the total weight of the alloy. The designation of alloys is compliant with the rules of The Aluminum Association (AA), known to those skilled in the art. The density depends on the composition and is determined by calculation rather than by a method of weight measurement. The values are calculated in compliance with the procedure of The Aluminum Association, which is described on pages 2-12 and 2-13 of “Aluminum Standards and Data”. The definitions of the metallurgical states are indicated in European standard EN 515.

Unless otherwise stated, the static mechanical properties, in other words the ultimate tensile strength Rₘ, the yield stress under stretching R_{p0.2} and elongation at break A, are determined by a tensile test according to standard EN 10002-1 or NF EN ISO 6892-1, the place at which the parts are held and their direction being defined by standard EN 485-1.

The stress intensity factor (K_{Q}) is determined according to standard ASTM E 399. The proportion of test specimens defined in paragraph 7.2.1 of this standard is therefore always respected, as is the general procedure defined in paragraph 8. Standard ASTM E 399 in paragraphs 9.1.3 and 9.1.4 gives criteria which make it possible to determine whether K_{Q} is a valid value of K_{1C}. So a value K_{1C} is always a value K_{Q} but the converse is not true. Within the framework of the invention, the criteria of paragraphs 9.1.3 and 9.1.4 of standard ASTM E399 are not always respected; however for a given test specimen geometry, the values of K_{Q} presented are always comparable with one another, the test specimen geometry making it possible to obtain a valid value of K_{1C} not always being accessible given the constraints related to the dimensions of the sheets or profiles. Within the framework of the invention, the thickness of the selected test specimen is a thickness considered as suitable by experts in the field to obtain a valid K_{1C}.

The critical stress intensity factor (K_{c}) and the apparent critical stress intensity factor (Kₐₚₚ) are as defined in ASTM standard E561.

Unless otherwise specified, the definitions of standard EN 12258 apply. The thickness of the profiles is defined according to standard EN 2066 :2001: the cross profile is divided into elementary rectangles of dimensions A and B; A being always the largest dimension of the elementary rectangle and B being regarded as the thickness of the elementary rectangle. The bottom is the elementary rectangle with the largest dimension A.

“Structural element” of a mechanical construction here refers to a mechanical for which the static and/or dynamic mechanical properties are particularly important for the performance of the structure, and for which a structural analysis is usually prescribed or performed. These are typically elements the failure of which is likely to endanger the safety of said construction, its users or others. For an aircraft, these structural elements include the parts which make up the fuselage (such as the fuselage skin, stringers, bulkheads, circumferential frames), the wings (such as the wing skin, stringers or stiffeners, ribs and spars) and the tail unit, made up of horizontal and vertical stabilizers, as well as floor beams, seat tracks and doors.

Unexpectedly, the inventors discovered that a low content of copper combined with simultaneous addition of manganese and zirconium makes it possible to obtain very high fracture toughness for aluminum-copper-lithium alloys, the density of which is lower than 2.66 g/cm3.

The copper content of the alloy for which the surprising effect is observed lies from 2.1 to 2.4% by weight or even from 2.10 to 2.40% by weight, preferably from 2.12 or 2.20 to 2.37% or 2.30% by weight.

The lithium content lies from 1.3 to 1.6% or even from 1.30 to 1.60% by weight. In an advantageous embodiment the lithium content is from 1.35 to 1.55% by weight. The silver content lies from 0.1 to 0.5% by weight. The inventors noted that a large amount of silver may not be necessary to obtain the desired improvement in the compromise between mechanical resistance and damage tolerance. In an advantageous embodiment of the invention, the silver content is from 0.15% to 0.35% by weight. In one embodiment of the invention, which has the advantage of minimizing density, the silver content is at the most 0.25% by weight.

The magnesium content lies from 0.2 to 0.6% by weight and preferably is less than 0.4% by weight.

The simultaneous addition of zirconium and manganese is an important characteristic of the invention. The zirconium content advantageously should lie from 0.05 to 0.15% by weight and the manganese content advantageously should lie from 0.1 to 0.5% by weight. The alloy also contains from 0.01 to 0.12% by weight of Ti, i.e. in order to control the grain size during casting.

The alloy according to the invention may also optionally contain at least one element chosen among Cr, Sc, and Hf, the amount of the element, if it is chosen, being from 0.05 to 0.3% by weight for Cr and Sc, 0.05 to 0.5% by weight for Hf.

It is preferable in some cases to limit the content of the inevitable impurities of the alloy in order to obtain the most favorable damage tolerance properties.

The inevitable impurities include iron and silicon; these elements each have a content of less than 0.1% by weight and preferably a content of less than 0.08% by weight and 0.06% by weight for iron and silicon, respectively; the other impurities each have a content of less than 0.05% by weight and 0.15% by weight in total. In addition the zinc content is preferably less than 0.04% by weight.

Preferably, the composition is adjusted in order to obtain a density at room temperature of less than 2.65 g/cm3. Still more preferably less than 2.64 g/cm3 or even in certain cases less than 2.63 g/cm3.

The combination of desirable properties: low density, high fracture toughness and sufficient mechanical resistance are difficult to obtain simultaneously Within the framework of the invention, it is surprisingly possible to combine a low density with a very advantageous compromise of mechanical properties.

The alloy according to the invention can be used to manufacture extruded, rolled or forged products. Advantageously, the alloy according to the invention can be used to manufacture sheets.

The products according to the invention preferably have a primarily unrecrystallized structure, with a recrystallization rate of less than 30% and preferentially less than 15%.

The extruded products and in particular the extruded profiles obtained by the process according to the invention are advantageous. Thick profiles, i.e. for which the thickness of at least one elementary rectangle is greater than 8 mm, and preferably greater than 12 mm, or even 15 mm are the most advantageous. Advantageously, the thick profiles according to the invention include
a yield stress R_{p0.2} in direction L of at least 390 MPa and preferably of at least 400 MPa and even more preferably of at least 430 MPa and
a fracture toughness K_{Q}(L−T), of at least 64 MPa\sqrt{m} and preferably of at least 65 MPa\sqrt{m}.

The alloy according to the invention is particularly advantageous for obtaining rolled products with very high fracture toughness. Of rolled products, heavy plates at least of 14 mm thick and preferably at least 20 mm and/or at the most 100 mm and preferably at the most 60 mm thick are advantageous.

Advantageously, heavy plates according to the invention include at mid thickness in state T84

(a) for a thickness of from 20 mm to 40 mm a yield stress R_{p0.2} in direction L of at least 410 MPa and preferably of at least 420 MPa and fracture toughness K_{Q}(L−T), of at least 45 MPa\sqrt{m} and preferably of at least 47 MPa\sqrt{m}.
(b) for a thickness of from 40 mm to 80 mm a yield stress R_{p0.2} in direction L of at least 380 MPa and preferably of at least 390 MPa and
fracture toughness K_{Q}(L−T), of at least 45 MPa\sqrt{m} and preferably of at least 50 MPa\sqrt{m}.

The products according to the invention have very high fracture toughness. The inventors suspect that possibly the simultaneous presence of Zr and Mn, which both can act to control the grain structure, makes it possible to obtain a very favorable primarily unrecrystallized structure, in particular for the preferred thicknesses of rolled and extruded products.

The products according to the invention can be obtained by a process including stages of casting, homogenization, hot working, solution heat-treatment, quenching, stress relieving and aging.

A suitable homogenization temperature is preferably from 480 to 540° C. for 5 to 60 hours. Preferably, the homogenization temperature lies from 515° C. to 525° C. so that the equivalent time t(eq) at 520° C. for homogenization lies from 5 to 20 hours and preferably from 6 to 15 hours. Equivalent time t(eq) at 520° C. is defined by the formula:

$$t ( eq ) = \frac{\int exp ( - 26100 / T ) d t}{exp ( - 26100 / {T}_{ref} )}$$

where T (in Kelvin) is the instantaneous treatment temperature, which changes with time t (in hours), and T_{ref} is a fixed reference temperature of 793 K. t(eq) is expressed in hours. The constant Q/R=26100 K is derived from the enablement energy of the diffusion of Mn, Q=217000 J/mol. The formula giving t(eq) takes account of the heating and cooling phases. In a preferred embodiment of the invention, the homogenization temperature is approximately 520° C. and the treatment time is from 8 to 20 hours.

After homogenization, the rough shape is in general cooled down to room temperature before being preheated ready for hot working. The purpose of preheating is to reach an initial bending temperature preferably ranging from 400 to 500° C. and preferably around 450° C. to 480° C. allowing the rough form to be worked.

Hot working is typically carried out by extrusion, rolling and/or forging in order to obtain an extruded, rolled and/or forged product.

The product obtained in this way then undergoes solution heat-treatment preferably by heat treatment from 490 to 530° C. for 15 min to 8 hours, then quenched typically with water.

The product then undergoes controlled stretching from 1 to 5% and preferably at least 2%. In one embodiment of the invention, cold rolling with a reduction ranging from 5% to 15% is performed before the controlled stretching stage. Known stages such as flattening, straightening or shaping may optionally be performed before or after controlled stretching.

Aging can be carried out at a temperature ranging from 120 to 170° C. for 5 to 100 h preferably from 150 to 160° C. for 20 to 60 h.

The preferred metallurgical states are states T84 and T89 for sheets and state T8511 for profiles.

Products according to the invention can be used as structural elements, in particular for aircraft construction.

In an advantageous embodiment of the invention, the products according to the invention can be used as elements of lower wing skin of an aircraft.

### EXAMPLES

### Example 1

The example of the invention is referred to as A. Examples B and C are presented for purposes of comparison. The chemical compositions of the various alloys tested in this example are given in table 1.

TABLE 1
Chemical composition (% by weight)

| Reference: | Si | Fe | Cu | Mn | Mg | Zn | Zr | Li | Ag | Ti |
|---|---|---|---|---|---|---|---|---|---|---|
| A | 0.03 | 0.05 | 2.37 | 0.29 | 0.37 | 0.01 | 0.13 | 1.37 | 0.28 | 0.04 |
| B | 0.03 | 0.05 | 2.50 | 0.31 | 0.35 | 0.01 | 0.13 | 1.43 | 0.25 | 0.04 |
| C | 0.03 | 0.06 | 2.62 | 0.30 | 0.35 | 0.01 | 0.14 | 1.42 | 0.24 | 0.04 |

The density of the various alloys tested is shown in table 2.

TABLE 2
Density of alloys tested

| | Density |
|---|---|
| Reference | (g/cm³) |
| A | 2.647 |
| B | 2.645 |
| C | 2.648 |

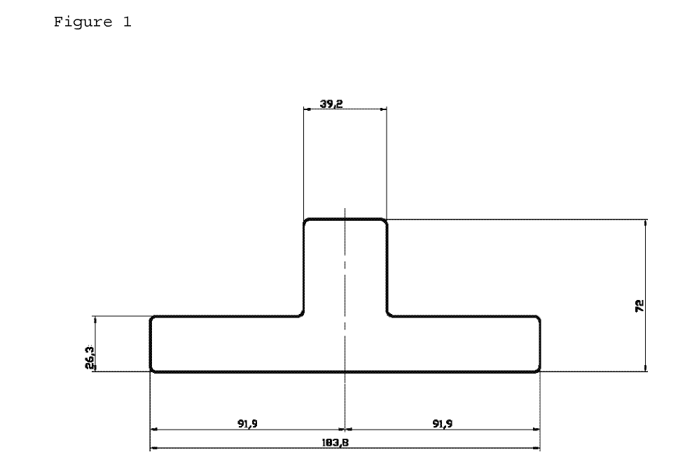

Alloys A, B and C were cast in the form of billets. The billets were homogenized 8 hours at 520° C. The equivalent time at 520° C. was 9.5 hours. After homogenization, the billets were heated to 450° C.+40° C. then hot spun to obtain profiles according to FIG. 1. The profiles obtained in this way underwent solution heat-treatment at 524+/−2° C., quenched with water at a temperature of less than 40° C., and stretched with a permanent elongation ranging between 2 and 5%. The profiles were aged for 30 hours at 152° C. corresponding to the maximum fracture toughness value.

The samples were taken on the bottom. The samples taken had a diameter of 10 mm except for direction T-L for which the samples had a diameter of 6 mm. The characteristics of the test specimens used for fracture toughness measurements were B=20 mm and W=76 mm.

The results obtained are given in table 3 below.

TABLE 3
Mechanical properties of profiles made of
alloy A, B and C.

| | Direction L | | | Direction TL | | | K_{Q} | |
|---|---|---|---|---|---|---|---|---|
| | Rₘ | R_{p0.2} | A | Rₘ | R_{p0.2} | A | (MPa\sqrt{m}) | |
| Alloy | (MPa) | (MPa) | (%) | (MPa) | (MPa) | (%) | L-T | T-L |
| A | 492 | 444 | 12.3 | 456 | 405 | 14.4 | 65.5 | 53.3 |
| B | 517 | 477 | 10.7 | 478 | 435 | 13.3 | 63.7 | 52.1 |
| C | 523 | 483 | 11.1 | 485 | 442 | 13.1 | 59.8 | 47.7 |

### Example 2

The examples of the invention are referred to as D and E. Examples F, G and H are presented for purposes of comparison. The chemical compositions of the various alloys tested in this example are given in table 4.

TABLE 4
Chemical composition (% by weight)

| Reference: | Si | Fe | Cu | Mn | Mg | Zn | Zr | Li | Ag | Ti |
|---|---|---|---|---|---|---|---|---|---|---|
| D | 0.03 | 0.05 | 2.21 | 0.38 | 0.28 | 0.01 | 0.13 | 1.46 | 0.25 | 0.04 |
| E | 0.03 | 0.05 | 2.28 | 0.40 | 0.30 | 0.01 | 0.14 | 1.50 | 0.27 | 0.04 |
| F | 0.03 | 0.06 | 3.12 | 0.30 | 0.41 | 0.01 | 0.10 | 1.78 | 0.35 | 0.03 |
| G | 0.03 | 0.06 | 2.64 | 0.41 | 0.33 | 0.02 | 0.14 | 1.55 | 0.26 | 0.03 |
| H | 0.03 | 0.05 | 3.02 | 0.45 | 0.35 | 0.01 | 0.14 | 1.43 | 0.28 | 0.03 |

The density of the various alloys tested is shown in table 5.

TABLE 5
Density of alloys tested

| | Density |
|---|---|
| Reference | (g/cm³) |
| D | 2.639 |
| E | 2.638 |
| F | 2.630 |
| G | 2.641 |
| H | 2.657 |

Alloys D, E, F, G and H were cast in the form of plates. The plates were homogenized for 8 hours at 520° C. After homogenization, the plates were heated then hot rolled to obtain sheets of thickness 14, 25 or 60 mm. The sheets obtained in this way underwent solution heat-treatment at 524+1/−2° C., were quenched with water at a temperature of less than 40° C., and stretched with a permanent elongation ranging between 3 and 50. The sheets were aged from 30 to 60 hours at 155° C.

The samples were taken at mid thickness for sheets of thickness 14 mm and 25 mm and at mid thickness and a quarter thickness for sheets of thickness 60 mm.

The test specimens used for fracture toughness measurements were 12.5 mm thick for sheets of thickness 14 mm, 20 mm for sheets of thickness 25 mm, 25 mm for sheets of thickness 60 mm, measured at quarter-thickness and 40 mm for sheets of thickness 60 mm measured at mid-thickness.

The results are given tables 5 to 9.

TABLE 5
Mechanical properties of a product according
to the invention, thickness 14 mm.

| | | Direction L | | | |
|---|---|---|---|---|---|
| | | Rₘ | R_{p0.2} | | K_{Q}, (L-T) |
| Alloy | Aging | (MPa) | (MPa) | A (%) | (MPa\sqrt{m}) |
| E | 30 H 155° C. | 473 | 431 | 9.0 | 35.6 |
| | 40 H 155° C. | 488 | 451 | 9.7 | 37.2 |
| | 50 H 155° C. | 490 | 454 | 9.3 | 37.7 |
| | 60 H 155° C. | 491 | 457 | 9.3 | 37.6 |

TABLE 6
Mechanical properties of a product according
to the invention (E) and reference products thickness
25 mm.

| | | Direction L | | | |
|---|---|---|---|---|---|
| | | Rₘ | R_{p0.2} | | K_{Q}, (L-T) |
| Alloy | Aging | (MPa) | (MPa) | A (%) | (MPa\sqrt{m}) |
| E | 30 H 155° C. | 473 | 430 | 10.8 | 48.9 |
| | 40 H 155° C. | 483 | 443 | 11.1 | 45.3 |
| | 50 H 155° C. | 492 | 456 | 10.8 | 45.6 |
| | 60 H 155° C. | 493 | 458 | 10.2 | 44.8 |
| F | 30 H 155° C. | 589 | 562 | 6.2 | 27.2 |
| | 40 H 155° C. | 594 | 566 | 6.2 | 23.8 |
| | 50 H 155° C. | 597 | 571 | 6.8 | 23.7 |
| G | 30 H 155° C. | 529 | 491 | 9.7 | 41.1* |
| | 40 H 155° C. | 534 | 499 | 9.7 | 39.6* |
| | 50 H 155° C. | 537 | 504 | 8.9 | 38.0* |
| | 50 H 155° C. | 535 | 503 | 9.1 | 35.4 |
| H | 30 H 155° C. | 558 | 524 | 9.2 | 35.3 |
| | 40 H 155° C. | 562 | 528 | 9.7 | 32.4 |
| | 50 H 155° C. | 565 | 532 | 8.9 | 31.0* |
| | 60 H 155° C. | 569 | 537 | 9.4 | 29.8 |

*K_{1C}

TABLE 7
Mechanical properties measured at mid-
thickness of a product according to the invention (D)
and of a reference product thickness 60 mm.

| | | Direction L | | | |
|---|---|---|---|---|---|
| | | | R_{p0.2} | | K_{Q}, (L-T) |
| Alloy | Aging | ² (MPa) | (MPa) | A (%) | (MPa\sqrt{m}) |
| D | 30 H 155° C. | 445 | 394 | 11.0 | 53.5 |
| | 40 H 155° C. | 465 | 423 | 11.0 | 48.9 |
| | 50 H 155° C. | 471 | 430 | 10.5 | 47.7 |
| | 60 H 155° C. | 469 | 428 | 10.,6 | 45.8* |
| H | 30 H 155° C. | 532 | 490 | 8.1 | 34.1 |
| | 40 H 155° C. | 541 | 500 | 7.8 | 32.4 |
| | 50 H 155° C. | 543 | 505 | 8.9 | 29.6 |
| | 60 H 155° C. | 541 | 503 | 7.6 | 28.3 |

*K_{1C}

TABLE 8
Mechanical properties measured at quarter-
thickness of a product according to the invention (D)
and of a reference product thickness 60 mm.

| | | Direction L | | | |
|---|---|---|---|---|---|
| | | Rₘ | R_{p0.2} | | K_{Q}, (L-T) |
| Alloy | Aging | (MPa) | (MPa) | A (%) | (MPa\sqrt{m}) |
| D | 30 H 155° C. | 451 | 412 | 10.9 | 47.6 |
| | 40 H 155° C. | 456 | 422 | 11.6 | 42.6 |
| | 50 H 155° C. | 459 | 427 | 11.4 | 42.9* |
| | 60 H 155° C. | 465 | 431 | 11.4 | 38.9 |
| H | 30 H 155° C. | 515 | 485 | 10.9 | 33.4 |
| | 40 H 155° C. | 525 | 496 | 10.4 | 29.7 |
| | 50 H 155° C. | 525 | 497 | 9.0 | 26.3 |
| | 60 H 155° C. | 524 | 497 | 8.9 | 26.4 |

*K_{1C}

TABLE 9
Stress intensity factors measured at mid
thickness for CCT sample specimen with a width W = 406
mm.

| | | | Kₐₚₚ, (L-T) | K_{ceff}, (L-T) |
|---|---|---|---|---|
| Alloy | Thickness (mm) | Aging | (MPa\sqrt{m}) | (MPa\sqrt{m}) |
| E | 14 | 36 H 155° C. | 108 | 136 |
| E | 25 | 46 H 155° C. | 112 | 148 |
| G | 25 | 30 H 155° C. | 100 | 117 |
| H | 25 | 30 H 155° C. | 94 | 108 |
| D | 60 | 36 H 155° C. | 117 | 164 |
| H | 60 | 30 H 155° C. | 90 | 105 |
| D | 40 | 46 H 155° C. | 117 | 158 |

1. An aluminum alloy comprising:
2.1 to 2.4% by weight of Cu,
1.3 to 1.6% by weight of Li,
0.1 to 0.5% by weight of Ag,
0.2 to 0.6% by weight of Mg,
0.05 to 0.15% by weight of Zr,
0.1 to 0.5% by weight of Mn,
0.01 to 0.12% by weight of Ti
optionally at least one element selected from the group consisting of Cr, Sc, and Hf, the amount of the element, if present, being from 0.05 to 0.30 by weight for Cr and Sc, 0.05 to 0.5% by weight for Hf,
a quantity of Fe and Si each less than or equal to
0.1% by weight,
remainder aluminum and inevitable impurities each with a content less than or equal to 0.05% by weight one and 0.15% by weight in total.

2. An aluminum alloy according to claim 1 including 2.12 to 2.37% of Cu by weight.

3. An aluminum alloy according to claim 1 including 2.20 to 2.30% of Cu by weight, 1.35 to 1.55% of Li by weight, 0.15 to 0.35% of Ag by weight, 0.2 to 0.4% of Mg by weight.

4. An extruded, rolled and/or forged product including an alloy according to claim 1.

5. A product according to claim 4 with a recrystallization rate of less than 30%.

6. A product according to claim 4 comprising a profile for which a thickness of at least one elementary rectangle is greater than 8 mm.

7. A product according to claim 6 comprising
a yield stress R_{p0.2} in direction L of at least 390 MPa and
a fracture toughness K_{Q}(L−T), of at least 64 MPa\sqrt{m}.

8. A product according to claim 4 comprising a rolled product of which the thickness is at least 14 mm.

9. A product according to claim 8 including at mid-thickness in state T84
(a) for a thickness of from 20 mm to 40 mm, a yield stress R_{p0.2} in direction L of at least 410 MPa, and a fracture toughness K_{Q}(L−T), of at least 45 MPa\sqrt{m},
(b) for a thickness of from 40 mm to 80 mm, a yield stress R_{p0.2} in direction L of at least 380 MPa, and a fracture toughness K_{Q}(L−T), of at least 45 MPa\sqrt{m}.

10. A manufacturing process for a product comprising:
(a) casting a rough alloy shape wherein said alloy comprises an alloy according to claim 1
(b) homogenizing said rough form at 480 to 540° C. for 5 to 60 hours,
(c) hot working said rough form by extrusion, rolling and/or forging at an initial hot working temperature of 400 to 500° C. into an extruded, tolled an/or forged product,
(d) solution heat treating said product at 490 to 530° C. for 15 minutes to 8 hours,
(e) quenching said product,
(f) subjecting said product to controlled stretching with a permanent set of 1 to 5%,
(g) aging said product by heating to a temperature of 120 to 170° C. for 5 to 100 hours.

11. An element of lower wing skin of an aircraft comprising a product of claim 5.

12. A product according to claim 4 with a recrystallization rate of less than 15%.

13. A product according to claim 4 comprising a profile for which a thickness of at least one elementary rectangle is greater than 12 mm.

14. A product according to claim 6 comprising
a yield stress R_{p0.2} in direction L of at least 400 MPa and a fracture toughness K_{Q}(L−T), of at least 65 MPa\sqrt{m}

15. A product according to claim 4 comprising a rolled product of which the thickness is at least 20 mm.

16. A product according to claim 8 including at mid-thickness in state T84
(a) for a thickness of from 20 mm to 40 mm, a yield stress R_{p0.2} in direction L of at least 420 MPa, and a fracture toughness K_{Q}(L−T), of at least 47 MPa\sqrt{m},
(b) for a thickness of from 40 mm to 80 mm, a yield stress R_{p0.2} in direction L of at least 390 MPa, and a fracture toughness K_{Q}(L−T), of at least 50 MPa\sqrt{m}.
